(19) United States
(12) Patent Application Publication
(10) Pub. No.: US 2024/0338945 A1
(43) Pub. Date: Oct. 10, 2024

(54) MONITORING DEFINED OPTICAL PATTERNS BY MEANS OF OBJECT DETECTION AND MACHINE LEARNING

(71) Applicant: FRAUNHOFER-GESELLSCHAFT ZUR FÖRDERUNG DER ANGEWANDTEN FORSCHUNG E.V., München (DE)

(72) Inventor: Matthias STAMMLER, Bremenhaven (DE)

(73) Assignee: FRAUNHOFER-GESELLSCHAFT ZUR FÖRDERUNG DER ANGEWANDTEN FORSCHUNG E.V., München (DE)

(21) Appl. No.: 18/579,388

(22) PCT Filed: Jul. 14, 2022
(86) PCT No.: PCT/EP2022/069797

§ 371 Date: Jan. 15, 2024

(30) Foreign Application Priority Data
Jul. 15, 2021 (DE) 102021207568.1

(51) Int. Cl. G06V 20/52; G06F 16/583; G06V 10/70; G06V 20/62

(52) U.S. Cl. CPC G06V 20/52; G06F 16/5846; G06V 10/70; G06V 20/63

(57) ABSTRACT

The invention relates to a system for monitoring technical installations, comprising symbols (1) that are provided on parts of technical installations to be monitored in a surrounding area; at least one camera (2) that acquires image data of the surrounding area and applies spatial coordinates and a recording point in time thereto; an image database (4) in which the image data are archived; a symbol library (5) in which a plurality of symbols (1) and rules assigned thereto are stored; and an object recognition unit (3), which is designed to recognize symbols (1) in the image data and compare these to the symbols (1) stored in the symbol library (4), wherein a spatial coordinate is assigned to a symbol (1) when the symbol (1) is recognized in the image data, a comparison to earlier image data of the surrounding area is carried out, and an alarm is triggered when a rule that is assigned to the recognized symbol (1) is not adhered to.

The invention relates to a system for monitoring technical installations by means of object recognition of defined optical patterns. Furthermore, a method for monitoring technical installations by means of object recognition of defined optical patterns is described.

Regular monitoring is needed to ensure the functional capability and safety of all types of technical installations. In the process, either trained staff can check the state of the installations at defined time intervals, or specific sensors monitor the installations with respect to certain characteristic variables that reflect the functional capability of the installations. However, some states of technical installations, such as, for example, whether a screw has been properly tightened or has become loose, can only be detected with difficulty by way of sensors. On the other hand, a visual check by staff is cost-intensive, in particular in locations that are difficult to access.

Automated optical monitoring systems are one alternative. However, these are, in general, not flexible enough to reliably detect a plurality of states that may occur on an installation, and are consequently limited to individual states. The patent specification DE 10 2016 214 705 A1, for example, describes a system for monitoring the state of screw connections. A cost-effective automatic system that, for example, is able to optically monitor both the state of a screw connection and the angle of other components with respect to one another would thus be of great interest.

It is therefore an object of the present property right application to provide such an automatic system for optically monitoring technical installations. Moreover, a simple method for optically monitoring technical installations is provided.

This object is achieved by a system for monitoring technical installations according to the independent claim 1. A method for monitoring technical installations is provided in claim 10. Further embodiments can be derived from the dependent claims.

A system for monitoring technical installations comprises symbols that are provided on parts of technical installations to be monitored in a surrounding area; at least one camera that acquires image data of the surrounding area and applies spatial coordinates and a recording point in time thereto;
an image database in which the image data are archived;
a symbol library in which a plurality of symbols and rules assigned thereto are stored; and an object recognition unit, which is designed to recognize symbols in the image data and compare these to the symbols stored in the symbol library,
wherein a spatial coordinate is assigned to a symbol when the symbol is recognized in the image data,
a comparison to earlier image data of the surrounding area is carried out, and an alarm is triggered when a rule that is assigned to the recognized symbol is not adhered to.

In contrast to known optical monitoring systems, the monitoring process is not limited to the state of a specific component, such as, for example, a screw connection, but instead to the monitoring of symbols provided on the installations. The symbols are simple optical patterns that can, for example, be based on geometric basic shapes. These symbols form a defined symbol language in which a rule that can be optically checked is assigned to each symbol. These rules can apply to the rotational state or the visibility of a symbol, for example. The symbols are not limited in terms of the size and design thereof, so that these can be adapted to a plurality of application purposes and surrounding conditions.

The symbols are provided on the parts of a technical installation which are to be monitored. For this purpose, these may be implemented as labels, or they may be painted on using a stencil. The symbols are provided on parts to which the rules assigned to the symbols are to apply. For example, a symbol to which a rule is assigned that states that the symbol must not rotate in the loosening direction of the screw connection may be provided on a screw connection that is not to become loose.

At least one camera is configured to monitor the installation. It is also possible to use several cameras so as to obtain different viewing angles of the installation. This may be a camera comprising conventional optical sensors, or this may also be a device that is able to create recordings outside the optical spectrum, for example in the infrared range, in accordance with special requirements of the surrounding area. The camera acquires image data of the technical installation at defined intervals. These data are additionally provided with pieces of information about the recording location, the special coordinates, and the recording point in time.

The system moreover includes an image database. The image data acquired by the at least one camera are stored therein. In this way, it is made possible to compare image data of different recording points in time. The database can be created as a local storage medium or may be connected to the remaining system via a network.

The symbol library describes the defined symbol language. This includes a storage medium encompassing a database, in which examples of all symbols used are archived. At least one rule is assigned to each symbol in the symbol library. The symbol library can be expandable.

The core of the system is an object recognition unit, which processes the image data acquired by the camera. The object recognition unit utilizes a combination of static and dynamic algorithms for recognizing the defined symbols in the image data. In the process, it recognizes symbols based on the shape, coloring, and reflective properties thereof. The object recognition unit is furthermore designed to detect the state of the recognized symbol, that is, for example, a rotation or soiling. In the process, a plurality of different methods may be employed. A method for recognizing the symbols may be selected as a function of the properties of the surrounding area and the properties of the defined symbols. The object recognition unit can be a processor, which executes specialized software. However, it may also be a network of processors or specialized electronics.

When recognizing a symbol that is stored in the symbol library in the image data, the object recognition unit determines the spatial coordinates thereof from the image data. In addition, a comparison to image data acquired in the same surrounding area at an earlier recording point in time is carried out. When the symbol is detected for the first time in this surrounding area, it is a symbol that has been newly provided on the installation to be monitored. The image data are thereupon saved to the image database and are available there for later comparisons. When a symbol is recognized for the second or repeated time in the image data based on a spatial coordinate, the object recognition unit checks that the rule stored for this symbol in the symbol library is adhered to. If the rule is adhered to in the newly acquired image data, no further action is taken. If, however, the object recognition recognizes a change in the state of the symbol which conflicts with the stored rule, the system outputs an alarm signal. Based on the alarm signal, maintenance work of the installation can then be carried out, or other necessary steps can be initiated.

By monitoring the symbols provided on the technical installation, the system can also monitor the state of the technical installation in a simple manner. The system is extremely flexible since the symbol library can be expanded at any time, and new symbols can be provided on the installation. Since a plurality of different rules can be assigned to the symbols, the system is also not limited to monitoring a single state. Since the system operates completely automatically, the monitoring process can be carried out at arbitrary intervals or permanently.

The at least one camera can be fixedly installed. This simplifies the determination of the spatial coordinates of the image data and of the symbols recognized therein since the position of the camera and the viewing angle thereof can be precisely defined. In this embodiment, one or more monitoring cameras can be provided in the surrounding area of the technical installation to be monitored so as to acquire different viewing angles.

The at least one camera, however, can also be implemented in a mobile manner. For example, it may be attached to a drone or a robotic arm, or be implemented as part of a hand-held device, such as a smartphone, for example. Such a design of the camera allows technical installations to be checked at defined intervals, even in positions that are difficult to access. Nonetheless, it is not necessary to fixedly install several cameras for monitoring larger installations. In particular when the camera is implemented as a drone, the system can be designed to operate autonomously.

Depending on the design of the at least one camera, the camera may comprise a device for position determination, a device for determining the recording angle, and a device for distance determination. A device for position determination is used to provide the acquired image data with spatial coordinates. This is in particular necessary with mobile designs of the camera in which the position of the camera is not defined. For example, this may simply be a system for position determination by way of GPS. Using a device for distance determination, it is possible to determine the distances between the symbols recognized in the surrounding area and the camera. So as to be able to determine the spatial coordinates of the symbols, the recording angle of the camera is additionally required. A device for determining the recording angle can, for example, be based on acceleration sensors or on a gyrocompass.

The device for distance measurement can, for example, encompass a laser range finder. This may be used to reliably determine the distances between the at least one camera and the parts of the technical installation of which image data are being acquired. The distance measurement can also be carried out in a purely optical manner, via the camera focus setting. In commercially available modern digital cameras, such a distance measurement for setting the autofocus function is usually carried out by way of an edge contrast measurement or by way of a phase comparison.

The symbols provided on a technical installation can be such that these stand out against the surrounding area thereof particularly well as a result of the coloring and reflective properties thereof. This simplifies the recognition of the symbols by the object recognition unit. For example, it is possible to use colors that otherwise do not occur in the surrounding area or that have a highly reflective or fluorescent effect. Likewise, the symbols can be implemented as labels, which are made of materials that, as a result of the surface properties thereof, attain particularly good visibility.

The symbol language that is used can be defined in such a way that the assigned rules not only apply to individual symbols, but can also relate several symbols to one another. For example, rules with respect to the distance or angle between two symbols can be established. The symbol library then assigns these rules to the corresponding symbols.

The object recognition unit can utilize a machine learning-based model for recognizing the defined symbols in the image data. Such a model initially has to be trained in recognizing the symbols, but then offers greater flexibility in terms of the recording angle and ambient influencing factors based on which the symbols can be recognized. While it is possible to recognize the symbols in the image data by way of such a model, the assignment of the recognized symbols to the symbols and rules stored in the symbol library can continue to be carried out using static algorithms.

The entire system for monitoring technical installations can be implemented as a computer, which comprises the object recognition unit, the image database and the symbol library, or which executes corresponding programs, and is connected to the at least one camera for acquiring the image data. Such a computer may be present locally at the monitoring site. However, this may also be a mainframe computer, which receives the data via a network from a plurality of static or movable cameras, and thus allows several technical installations to be monitored simultaneously.

A method for monitoring technical installations comprises the following steps: optically acquiring a surrounding area by a camera for producing image data;
preparing the image data by an object recognition unit, wherein the image data are provided with spatial coordinates and a recording point in time;
recognizing symbols in the image data by the object recognition unit, wherein a spatial coordinate is assigned to the symbols;
assigning recognized symbols to symbols stored in a symbol library;
comparing the recognized symbols to image data that were acquired at the same spatial coordinates at earlier recording points in time; and
evaluating the recognized symbols, wherein
when no symbols are present in the image data of earlier recording points in time, or if a recognized symbol was not recognized in the image data of earlier recording points in time, the image data are saved;
when the recognized symbols were recognized in the image data of earlier recording points in time and no change is recognized that violates a rule assigned to the recognized symbols, no further actions are carried out; and
when the recognized symbols were recognized in the image data of earlier recording points in time and a change is recognized that violates a rule assigned to the recognized symbols, an alarm is triggered.

In a first step, image data of the surrounding area are acquired by a camera. These image data are forwarded to the object recognition unit, where the image data are prepared for further processing in a second step. In particular, the image data are provided with spatial coordinates and the recording point in time. In a third step, the object recognition unit carries out the algorithms for recognizing the defined symbols in the image data. In the process, spatial coordinates calculated from the image data to the recognized symbols. In a fourth step, the recognized symbols are assigned to the symbols stored in the symbol library. Rules are assigned to each of the symbols stored in the symbol library. Thus, when a symbol is recognized in the image data and is successfully assigned to a symbol defined in the symbol library, it is also known which rule is to apply to the recognized symbol. In a fifth step, the image data are compared to image data recorded at the same spatial coordinates at earlier recording points in time. During the evaluation following in the sixth step, three different results may thus be obtained. If no symbol was recognized in the image data of the earlier recording point in time or no symbol that was recognized in the new image data is present, the new image data are saved so as to enable a comparison thereto at a later point in time, and thus allow the adherence of the rules of the recognized symbol to be checked. If the recognized symbol was also recognized in the image data of earlier recording points in time, it is checked whether the state of the symbol recognized in the new image data corresponds to the rules assigned to the symbol. If this is the case, no action takes place, and the monitoring process can proceed continuously or at a later point in time. If, however, a change in the symbol is recognized which violates a rule assigned to the symbol, an alarm signal is output.

The second step of preparing the image data for further processing can additionally comprise that the image data are provided with data indicating the spatial coordinates of the recording camera, the distance between the camera and the technical installation to be detected, and the recording angle thereof. From this data, it is then possible to determine the spatial coordinates of the recognized symbols.

The second step of preparing the image data for further processing can additionally comprise that the image data are initially preprocessed and filtered. In the process, for example, the contrast can be adjusted and certain colors can be filtered, or algorithms can be used for noise suppression or for edge detection.

So as to render the defined symbols more easily recognizable in the step of recognizing, these may be designed so as to stand out particularly well against the surrounding area thereof as a result of the coloring and reflective properties thereof. For example, it is possible to use colors that otherwise do not occur in the surrounding area or that have a highly reflective or fluorescent effect. Likewise, the symbols can be implemented as labels, which are made of materials that, as a result of the surface properties thereof, attain particularly good visibility.

During the assignment of the recognized symbols to the symbols stored in the symbol library, the symbol library can also assign rules to the symbols which relate several symbols to one another. In this way, the rules can also apply to relationships between two symbols, such as the distance or angle.

In the step of recognizing the symbols in the image data, a machine learning-based model may be utilized for recognizing the defined symbols in the image data. Such a model initially has to be trained in recognizing the symbols, but then offers greater flexibility in terms of the recording angle and ambient influencing factors based on which the symbols can be recognized. While it is possible to recognize the symbols in the image data by way of such a model, the assignment of the recognized symbols to the symbols and rules stored in the symbol library can continue to be carried out using static algorithms.

The described system as well as the method for monitoring technical installations allow cost-effective automatic monitoring of technical installations. The system and the method can thus be used in multifaceted application options when it comes to enhancing the safety of technical installations and make the maintenance thereof easier to plan. Such a system can, in particular, be used in locations that would be difficult to access or hazardous to human staff.

The described embodiments of the subject matter of the present application can be used individually as well as be combined to achieve additional effects, and to create a simple and flexible system and method for monitoring technical installations by means of object recognition of defined optical patterns.

The aforementioned aspects, as well as further aspects of the invention, will become evident based on the detailed description of the exemplary embodiments, which is provided with the aid of the following drawings, in which:

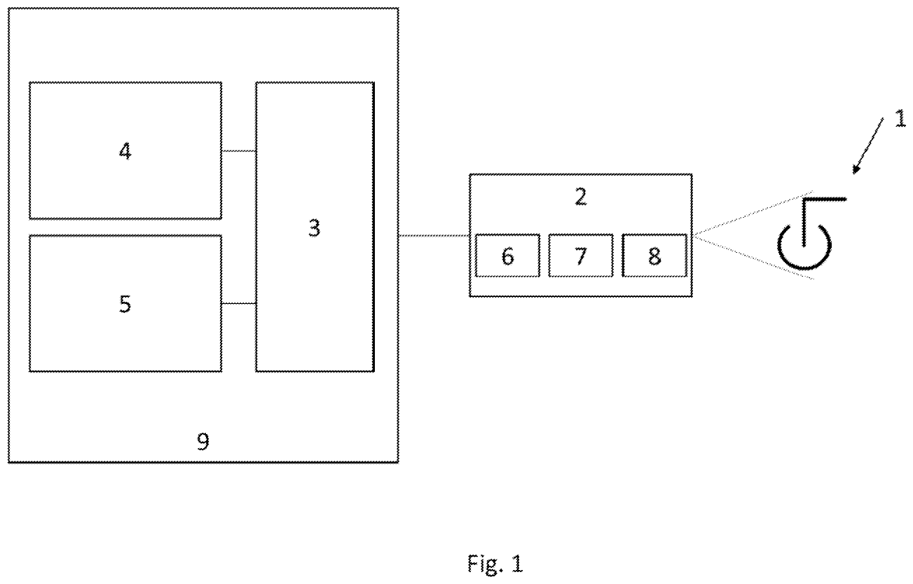

FIG. 1 shows a schematic overview of a system according to the invention for monitoring technical installations;

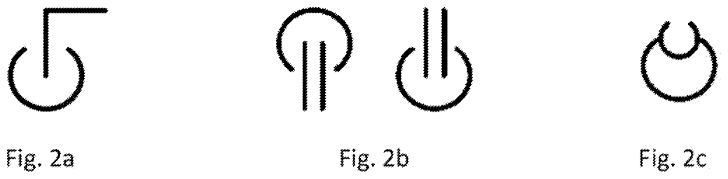

FIGS. 2a, 2b and 2c show examples of the defined symbols; and

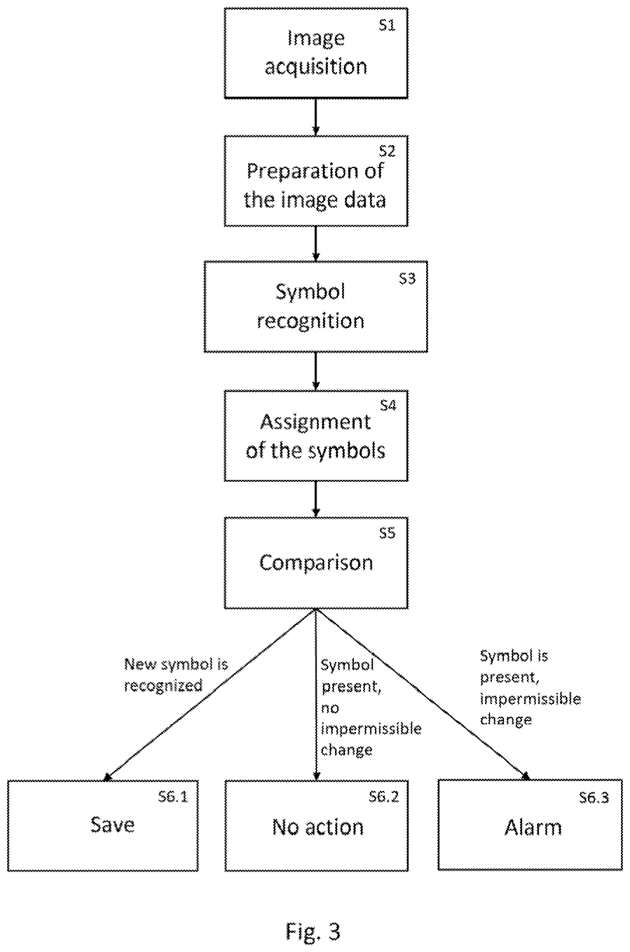

FIG. 3 represents the sequence of the method for monitoring technical installations.

Hereafter, the claimed subject matter shall be described in greater detail based on the accompanying drawings. Identical reference numerals refer to identical elements.

FIG. 1 shows a schematic overview of one embodiment of the system for monitoring technical installations. A symbol 1 is attached to a technical installation or in the surrounding area of a technical installation. The camera optically detects the surrounding area of the technical installation. For this purpose, the camera 2 can be fixedly installed in the surrounding area or be designed to be mobile, for example as part of a drone. If it is fixedly installed, the position thereof is known, and the recording angle thereof and the distance thereof with respect to various parts of the technical installation can be easily calculated or measured. In the case of a mobile design of the camera 2, it is additionally necessary to determine the position of the camera 2, the recording angle, and the distance with respect to the detected objects. Both a static and a mobile design of the camera 2 can thus include a device for position determination 6, for example a GPS receiver, a device for determining the recording angle 7, for example an acceleration sensor, and a device for distance measurement 8, for example a laser range finder. As an alternative, the distance measurement can, for example, also be determined by way of the focus setting of the camera 2. In this way, it is possible to precisely assign pieces of information to the image data acquired by the camera 2, from which, during the further course, the spatial coordinates of the objects detected in the image data can be calculated. In addition, an internal clock detects the recording point in time of the image data.

The image data are forwarded by the camera 2 to an object recognition unit 3. In the illustrated embodiment, this is part of a processor 9, together with the image database 4 and the symbol library 5. These elements, however, do not have to be part of an individual processor, and may also be a network of processors or specialized circuits in different locations. Likewise, the data transmission from the camera 2 to the object recognition unit 3 can be carried out via a cable connection; however, it may also take place by wireless data transmission. The data transmission can likewise be carried out via larger networked structures, such as the Internet.

The image data may be preprocessed in the object recognition unit 3. In the process, various algorithms can be applied to the image data to remove interfering effects from the data, such as noise, or to highlight elements that are advantageous for the object recognition process, such as edges. It may also be useful to apply certain color filters to the acquired image data if the symbols to be recognized have corresponding coloring.

The actual object recognition can then be carried out through the use of a machine learning-based model that was trained with the aid of the defined symbols. The model thereupon recognizes the symbols based on specific properties. The use of such a model yields greater flexibility in the object recognition process in terms of influencing factors of the surrounding area, such as poor illumination of the object to be detected or certain recording angles. When a symbol 1 is recognized in the image data, the object recognition unit determines the spatial coordinates of the recognized symbol 1 with the aid of the additional pieces of information of the image data.

The symbol library 5 encompasses a plurality of definitions of symbols, and assigns rules thereto. During the comparison to the symbols stored in the symbol library 5, it is possible to recognize the recognized symbol 1 as one of the defined symbols, and a rule can likewise be assigned thereto.

So as to check the adherence to this rule, the acquired image data are compared to image data saved to the image database 4, which were acquired at earlier recording points in time at the spatial coordinates of the recognized symbol. If a violation of the assigned rule is noticed in the process, an alarm signal is output to initiate maintenance work, for example. Regardless of the outcome of the check, the acquired image data can be saved in the image database 4 to allow a comparison later on.

So as to mark the technical installations to be monitored and recognize the states thereof, a defined symbol language is used. FIGS. 2a, 2b and 2c show examples of such symbols. The shown examples are all based on a circle that is provided with a cut-out; however, other geometric basic shapes which are well-suited for object recognition are also conceivable for such a symbol language. So as to enable reliable object recognition, the symbols preferably have as simple a design as possible. The shape and coloring of the symbols furthermore must be designed so as to be easily recognizable in the surrounding area thereof and clearly distinguishable from one another. Rules are assigned to each symbol or pairs or groups of symbols, which are used to assess the state of the technical installation to be monitored.

For example, the rule “This symbol must not rotate about the normal in the plane thereof” is assigned to the symbol shown in FIG. 2a. When this symbol is thus provided on a screw connection, the system effectively monitors whether the screw connection carries out a rotational movement and potentially becomes loose. A rotation can be noticed particularly easily due to the shape of the symbol.

FIG. 2b shows a combination of two symbols which are related to one another as a result of the rule “The angle between these two symbols must no change.” These two symbols can be provided on two components of an installation so as not to be permitted to move in terms of the angle thereof with respect to one another. The determination of the angular relationship between the two symbols is made possible by the double lines in the cut-outs of the circle of the symbols.

The symbols may also have non-geometric meanings. For example, the rule “This symbol must always remain visible once detected” may be assigned to the symbol shown in FIG. 2c. This symbol may thus be used to monitor the soiling of a surface, for example due to leakage. The symbols could also be used to recognize improper movement of a component or to mark an emergency exit to be kept clear.

The use of such a symbol language thus allows a plurality of states of a technical installation to be monitored, which otherwise are difficult to check automatically or require very specific sensors. In addition, a system that employs such symbols and machine learning-based object recognition is extremely flexible. For example, it is possible to recognize several symbols simultaneously in image data and relate these to one another. In addition, a symbol library 5 can be expanded, and new symbols can be provided on existing technical installations without major technical effort.

The sequence of the method for monitoring technical installations shall be described again with reference to the diagram in FIG. 3. In a first step S1, an image acquisition is carried out by a camera 2. Such an image acquisition can take place continuously or at defined intervals. The image data provided by the camera 2 are forwarded to an object recognition unit 3, which carries out the steps S2 and S3.

In the second step S2, the image data are initially prepared for further processing. This preparation S2 comprises providing the image data with pieces of information about the recording point in time, the spatial coordinates of the recording location, the recording angle, and the distance between the recorded objects and the camera. The preparation S2 of the image data can also comprise a preprocessing step, during which interfering effects are filtered out of the image data or algorithms for edge detection are applied thereto, so as to prepare the image data for the actual object recognition process in step S3.

The symbol recognition S3 can, in particular, be based on a model for machine learning that was trained to recognize the defined symbols in various circumstances. In this way, particularly good recognition can be ensured, with high flexibility of the system.

When a symbol is recognized in the image data, the method continues in step S4, in which the recognized symbol is assigned to a symbol stored in the symbol library 5. Such an assignment can also take place using static algorithms. At the same time, a rule is thus assigned to the recognized symbol.

So as to check the adherence to this rule, a comparison is carried out in step S5 between the acquired image data in which a symbol was recognized and image data acquired on an earlier recording date at the same spatial coordinates. If no earlier image data exist or the recognized symbol was not detected therein, this means that a method was carried out for the first time for this surrounding area or a symbol was newly provided on an installation. The acquired image data are thus saved in step S6.1 to the image data base 4 so as to enable a comparison later on. If the symbol recognized in the new image data was already recognized in image data of earlier recording points in time, but no change that violates the rule assigned to the symbol is noticed, no need for action exists in step S6.2. However, if the comparison between the new and old image data shows that a change that violates the rule assigned to the symbol has taken place at the technical installation, an alarm is triggered in step S6.3.

The sequence illustrated in FIG. 3 was described here based on the example of a single symbol. It is also possible, of course, for several defined symbols to be recognized in the image data. The processing of the individual symbols can take place consecutively or parallel to each other. In particular, several symbols can be recognized in a surrounding area and, as was already mentioned, can be related to one another.

The exemplary embodiments shown here are not limiting. In particular, it is possible to combine the features of these exemplary embodiments with one another so as to achieve additional effects. It is evident to a person skilled in the art that changes may be made to these exemplary embodiments without departing from the fundamental principles of the subject matter of the present property right application, the scope of which is defined in the claims.

1. A system for monitoring technical installations, comprising:
symbols (1) that are provided on parts of technical installations to be monitored in a surrounding area;
at least one camera (2) that acquires image data of the surrounding area and applies spatial coordinates and a recording point in time thereto;
an image database (4) in which the image data are archived;
a symbol library (5) in which a plurality of symbols (1) and rules assigned thereto are stored; and
an object recognition unit (3), which is designed to recognize symbols (1) in the image data and compare these to the symbols (1) stored in the symbol library (4),
wherein a spatial coordinate is assigned to a symbol (1) when the symbol (1) is recognized in the image data,
a comparison to earlier image data of the surrounding area is carried out, and
an alarm is triggered when a rule that is assigned to the recognized symbol (1) is not adhered to.

2. The system according to claim 1, characterized in that the at least one camera (2) is fixedly installed.

3. The system according to claim 1, characterized in that the at least one camera (2) is mobile.

4. The system according to claim 1, characterized in that the at least one camera (2) comprises a device for position determination (6), a device for determining the recording angle (7), and a device for distance measurement (8) so as to determine the spatial coordinates of the image data.

5. The system according to claim 4, characterized in that the distance measurement (8) is carried out by a laser range finder or by setting a focus of the at least one camera.

6. The system according to claim 1, characterized in that the symbols (1) can be distinguished well from the surrounding area as a result of the coloring and reflective properties thereof.

7. The system according to claim 1, characterized in that the symbol library assigns rules to symbols (1) which relate a plurality of symbols (1) to one another.

8. The system according to claim 1, characterized in that the object recognition unit (3) utilizes a machine learning-based model for recognizing the symbols (1) in the image data.

9. The system according to claim 1, characterized in that the image database (4), the symbol library (5) and the object recognition unit (3) are parts of a processor (9) that is connected via a network to the at least one camera (2).

10. A method for monitoring technical installations, comprising the following steps:
optically acquiring a surrounding area (S1) by a camera for producing image data;
preparing the image data (S2) by an object recognition unit, wherein the image data are provided with spatial coordinates and a recording point in time;
recognizing symbols (S3) in the image data by the object recognition unit, wherein a spatial coordinate is assigned to the symbols;
assigning recognized symbols (S4) to symbols stored in a symbol library;
comparing the recognized symbols (S6) to image data that were acquired at the same spatial coordinates at earlier recording points in time; and
evaluating (S6) the recognized symbols, wherein
when no symbols are present in the image data of earlier recording points in time, or if a symbol was not recognized in the image data of earlier recording points in time, the image data are saved (S6.1);
when the recognized symbols were recognized in the image data of earlier recording points in time and no change is recognized that violates a rule assigned to the recognized symbols, no further actions are carried out (S6.2); and
when the recognized symbols were recognized in the image data of earlier recording points in time and a change is recognized that violates a rule assigned to the recognized symbols, an alarm is triggered (S6.3).

11. The method according to claim 10, characterized in that the image data are provided with spatial coordinates encompassing a position of the camera, a distance measurement and a recording angle.

12. The method according to claim 10, characterized in that the step of preparing the image data (S2) additionally comprises a preprocessing and a filtering of the image data.

13. The method according to claim 10, characterized in that the symbols can be distinguished well from the surrounding area as a result of the coloring and reflective properties thereof.

14. The method according to claim 10, characterized in that rules which relate a plurality of symbols to one another are assigned to the symbols.

15. The method according to claim 10, characterized in that a machine learning-based model is utilized for recognizing the symbols in the image data.
